(19) United States
(12) Patent Application Publication
(10) Pub. No.: US 2024/0325943 A1
(43) Pub. Date: Oct. 3, 2024

(54) GREASE INTERCEPTOR HAVING A BAFFLE

(71) Applicant: Advanced Drainage Systems, Inc., Hilliard, OH (US)

(72) Inventors: Alexander Shain, Lyme, CT (US); Solomon Marini, Littleton, MA (US); Paul Holbrook, Old Saybrook, CT (US)

(73) Assignee: Advanced Drainage Systems, Inc., Hilliard, OH (US)

(21) Appl. No.: 18/583,148

(22) Filed: Feb. 21, 2024

Related U.S. Application Data
(60) Provisional application No. 63/455,167, filed on Mar. 28, 2023.
(60) Provisional application No. 63/618,953, filed on Jan. 9, 2024.

(51) Int. Cl. B01D 21/00; C02F 1/40; C02F 101/32

(52) U.S. Cl. CPC B01D 21/0042; B01D 21/0033; C02F 1/40; C02F 2101/32

(57) ABSTRACT

Disclosed embodiments relate to a grease interceptor for treating wastewater by separating and retaining contaminants. In some embodiments, the grease interceptor may comprise a tank having a top wall, a bottom wall, opposing side walls, an upstream end wall, and a downstream end wall, a baffle extending transversely between the opposing side walls and dividing the tank lengthwise into a first chamber and a second chamber, wherein the baffle comprises, a hollow center compartment having an inflow opening for receiving a flow of wastewater and a slot opening for discharging the flow of wastewater into the first chamber, a first outer compartment and a second outer compartment located on opposing sides of the center compartment, wherein the first outer compartment and the second outer compartment each comprises an inlet opening for receiving the flow of wastewater from the first chamber and an outlet opening for discharging the flow of wastewater into the second chamber. The grease interceptor may further comprise an inflow pipe configured to direct the flow of wastewater from a source to the inflow opening and an outflow pipe configured to direct the flow of wastewater from the second chamber through an outlet standpipe to an outlet.

### CROSS REFERENCE TO RELATED APPLICATIONS

This application claims benefit of priority of U.S. Provisional Patent Application No. 63/455,167 filed Mar. 28, 2023 and U.S. Provisional Patent Application No. 63/618,953 filed Jan. 9, 2024. The content of the foregoing applications is incorporated herein by reference in their entirety.

### TECHNICAL FIELD

This disclosure relates generally to systems, methods, and devices for treating wastewater through a grease interceptor system, and more particularly, to treating wastewater through the use of a baffle within a grease interceptor system.

### BACKGROUND

Wastewater from a dwelling or commercial building is often treated by either an onsite subsurface system or by a community or municipal sewer system. A typical onsite system may comprise a septic tank within which solids settle out of the wastewater and anaerobic treatment of the wastewater takes place. The wastewater may then flow to a leach field for aerobic treatment. A typical municipal system may comprise an interconnected array of lateral sewer lines and mains connected to a mechanical and biological treatment system.

A common source of wastewater may be a restaurant or other food preparation facility where the wastewater may be largely from sinks and dishwashing machines. Such wastewater tends to contain a considerable quantity of contaminants, such as fats, oil, and grease. Removal of contaminants from the wastewater is required by municipal sewer systems regulations or to enable optimal septic tank functioning, as applies. Thus, a familiar practice is to first flow the source wastewater through a grease interceptor or grease trap.

Grease interceptor systems process wastewater to remove contaminants such as fats, oils, and grease. These systems may be used to separate contaminants from wastewater discharge flowing from kitchen or other food service waste streams. These systems temporarily store and divert wastewater streams for removal of contaminants before discharging filtered wastewater into the municipal sewer systems or septic tanks. Typically, a grease interceptor will be buried within the soil that is adjacent to the building that generates the wastewater. Alternatively, a grease interceptor may be located within a building interior space. Thus, it is desirable that grease interceptors be both efficient and compact.

In operation, a grease interceptor may comprise a tank that has a baffle or transverse wall that nominally divides the length of the tank into two chambers, typically of equal sizes. During grease interceptor operation, there is a net downstream flow of wastewater through the grease interceptor system. The baffle may impede flow of contaminants from the first chamber into the second chamber. Contaminants, which are typically lighter than water, may float to the top of the wastewater in the first chamber. Solids and semi-solids that may be present in the wastewater stream may sink to the bottom of the first chamber. Some anaerobic conversion of the contaminants and solids may also take place within the grease interceptor.

A typical grease interceptor baffle may have one or more openings at about mid-elevation, enabling relatively clear water to flow from the first chamber into the second chamber, where further separation of grease and oil may occur. Wastewater may then flow from the second chamber to a grease interceptor outlet that is in flow communication with a sewer system or a septic tank. Regulatory requirements often mandate the amount of grease and oil that may be present in the wastewater discharged to a municipal sewer system. Periodically, closures on the top of the grease interceptor may be opened to remove accumulated contaminants. Thus, a greater oil and grease storage capacity of a grease interceptor may result in less frequent and lower cost periodic cleanings.

Solutions are needed to provide improved grease interceptor systems. Such solutions should provide compact grease interceptor systems that may effectively separate contaminants from the flow of wastewater. Such solutions may provide a baffle within the grease interceptor system to allow contaminants to separate from the flow of wastewater in a first chamber and a second chamber of the grease interceptor systems. Such solutions may include the use of a baffle with one or more hollow compartments that may facilitate the separation of contaminants within the first chamber or second chamber of the grease interceptor. These solutions may allow for a more compact and efficient grease interceptor system.

### SUMMARY

The disclosed embodiments describe systems, methods, and devices for treating wastewater through a grease interceptor system, and more particularly, to treating wastewater through the use of a baffle within a grease interceptor system. These systems, methods, and devices may include a baffle configured to divide a tank into a first chamber and a second chamber. For example, in an embodiment, the baffle may comprise a hollow center compartment comprising an inflow opening for receiving a flow of wastewater and a slot opening for discharging the flow of wastewater into the first chamber, and a first outer compartment and a second outer compartment located on opposing sides of the center compartment, wherein the first outer compartment and the second outer compartment each comprise an inlet opening for receiving the flow of wastewater from the first chamber and an outlet opening for discharging the flow of wastewater into the second chamber. In some embodiments, the first outer compartment and the second outer compartment may each comprise a hollow concavity.

In some embodiments, the inflow opening may be located at a top end of the center compartment. In other embodiments, the slot opening may comprise a horizontal slot opening. In some embodiments, the slot opening may be configured to discharge the flow of wastewater from the center compartment with an upward bias and a tendency toward laminar flow. In some embodiments, the inlet openings of the first outer compartment and the second outer compartment may be located below a mid-elevation of the baffle. In other embodiments, the inlet openings of the first outer compartment and the second outer compartment may be located at a one-quarter height of the baffle. In some embodiments, the outlet openings of the first outer compartment and the second outer compartment may be located above a mid-elevation of the baffle. In some embodiments, the outlet openings of the first outer compartment and the second outer compartment may be located at a two-thirds height of the baffle. In some embodiments, the center compartment may further comprise a protrusion, wherein the protrusion may comprise a hollow extrusion from a face of the center compartment. In some embodiments, the protrusion may be triangular in shape.

The disclosed embodiments may further include a grease interceptor for treating wastewater by separating and retaining contaminants. In some embodiments, the grease interceptor may comprise a tank having a top wall, a bottom wall, opposing side walls, an upstream end wall, and a downstream end wall, a baffle extending transversely between the opposing side walls, dividing the tank lengthwise into a first chamber and a second chamber, wherein the baffle comprises, a hollow center compartment comprising an inflow opening for receiving a flow of wastewater and a slot opening for discharging the flow of wastewater into the first chamber, a first outer compartment and a second outer compartment located on opposing sides of the center compartment, wherein the first outer compartment and the second outer compartment each comprise an inlet opening for receiving the flow of wastewater from the first chamber and an outlet opening for discharging the flow of wastewater into the second chamber, and an inflow pipe configured to direct the flow of wastewater from a source to the inflow opening, and an outflow pipe configured to direct the flow of wastewater from the second chamber through an outlet standpipe to an outlet.

In some embodiments, the inflow opening may be located at a top end of the center compartment. In some embodiments, the slot opening may comprise a horizontal slot opening. In other embodiments, the slot opening may be configured to discharge the flow of wastewater from the center compartment with an upward bias and a tendency toward laminar flow. In some embodiments, the center compartment may further comprise a protrusion, wherein the protrusion may comprise a hollow extrusion from a face of the center compartment. In some embodiments, the protrusion may be triangular in shape. In some embodiments, a cross sectional area of the slot opening may be larger than a cross sectional area of the inflow pipe. In other embodiments, a cross sectional area of the center compartment may increase with a decrease in elevation from a top of the baffle. In some embodiments, the slot opening may further comprise an integral molded boss.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 is a perspective view of a grease interceptor with part of the exterior tank cut away to show the baffle and other interior components, consistent with various embodiments of the present disclosure.

FIG. 2 is a side view of the grease interceptor of FIG. 1, consistent with various embodiments of the present disclosure.

FIG. 3 is a perspective view of the baffle of FIG. 1 showing the side which faces upstream within a grease interceptor tank, consistent with various embodiments of the present disclosure.

FIG. 4 is a perspective view of the baffle of FIG. 1 showing the side which faces downstream within a grease interceptor tank, consistent with various embodiments of the present disclosure.

FIG. 5 is a horizontal plane cross section of the baffle of FIG. 1 at uppermost elevation L1, consistent with various embodiments of the present disclosure.

FIG. 6 is a horizontal plane cross section of the baffle of FIG. 1 at mid-elevation L2, consistent with various embodiments of the present disclosure.

FIG. 7 is a horizontal plane cross section of the baffle of FIG. 1 at lower elevation L3, consistent with various embodiments of the present disclosure.

FIG. 8 is a perspective view of the baffle of FIG. 1 with arrows showing the flow of wastewater into and out of the baffle, consistent with various embodiments of the present disclosure.

FIG. 9 is a perspective view of the baffle of FIG. 1 with arrows showing how water flows out of the baffle, consistent with various embodiments of the present disclosure.

FIG. 10 is a top view of the interior of the grease interceptor embodiment of FIG. 1 with the tank top removed, showing the flow of wastewater to and from the compartments of the baffle and within the chambers, consistent with various embodiments of the present disclosure.

FIG. 11 is a vertical cross section of the grease interceptor embodiment of FIG. 1 showing the flow of wastewater within the baffle and the tank chambers, consistent with various embodiments of the present disclosure.

FIG. 12 is a semi-schematic vertical plane cross section view of the grease interceptor of FIG. 1 in combination with a downstream septic tank, consistent with various embodiments of the present disclosure.

FIG. 13 is a perspective view of the upper portion of the baffle of FIG. 1 showing a clean out opening at the top of the center compartment, consistent with various embodiments of the present disclosure.

FIG. 14 is a top view of a grease interceptor with an alternative embodiment of a baffle comprising two compartments, consistent with various embodiments of the present disclosure.

FIG. 15 is a perspective view of an alternative embodiment of a baffle comprising a center compartment having a concavity for downward flow of wastewater and opposing side panels that each have a passageway for wastewater flow in the downstream direction, consistent with various embodiments of the present disclosure.

FIG. 16 is a top view of the baffle of FIG. 15, consistent with various embodiments of the present disclosure.

FIG. 17 is a perspective view of a grease interceptor system containing an alternative embodiment of a baffle, consistent with various embodiments of the present disclosure.

FIG. 18 is a section cut of the grease interceptor system of FIG. 17, consistent with various embodiments of the present disclosure.

FIG. 19 is a view of the baffle of FIG. 17 showing the side of the baffle that faces upstream when installed within a grease interceptor tank, consistent with various embodiments of the present disclosure.

FIG. 20 is a view of the baffle of FIG. 17 showing the side of the baffle that faces downstream when installed within a grease interceptor tank, consistent with various embodiments of the present disclosure.

FIG. 21 is a perspective view of the upstream side of the baffle of FIG. 17 depicting a flow of wastewater through the grease interceptor system, consistent with various embodiments of the present disclosure.

FIG. 22 is a perspective view of the downstream side of the baffle of FIG. 17 depicting a flow of wastewater through the grease interceptor system, consistent with various embodiments of the present disclosure.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

A need has been recognized to provide an efficient and compact grease interceptor system. Existing grease interceptor systems may not effectively separate contaminants from the wastewater stream and may be too large for efficient underground installation. The disclosed embodiments improve these and other deficiencies in existing grease interceptor systems. For example, solutions are provided to allow for a compact and efficient grease interceptor system that maximizes the amount of contaminants separated from the flow of wastewater. The disclosed embodiments comprise a grease interceptor tank separated by a baffle into two chambers to allow for separation of contaminants from the flow of wastewater between the first chamber and the second chamber. The disclosed embodiments may further comprise a baffle with one or more hollow compartments that may allow contaminants to separate from the flow of wastewater in a first chamber and a second chamber of the grease interceptor system. Such disclosed embodiments may provide a compact grease interceptor that may effectively separate contaminants from a flow of wastewater.

References will now be made in detail to the disclosed embodiments, examples of which are illustrated in the accompanying drawings.

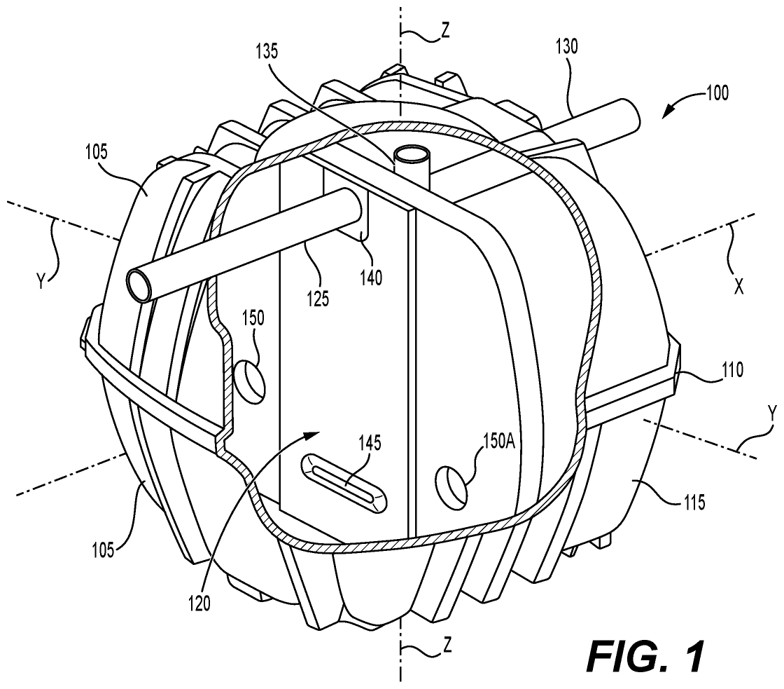

FIG. 1 depicts in partial cutaway an embodiment of grease interceptor 100 comprising tank 115, within which is a baffle 120, an inflow pipe 125, a standpipe 135, and an outflow pipe 130. Grease interceptor 100 may be made of molded polypropylene or polyethylene components and may be constructed in accord with the teachings of U.S. Pat. No. 8,740,005 directed to a “Plastic tank having a clamped joint,” the disclosure of which is hereby incorporated by reference. A tank and its associated baffle may alternatively comprise a material other than polypropylene or polyethylene; for instance, other polymers, fiberglass reinforced polyester resin, or concrete. Baffle 120 may be made by thermoforming two sheets and joining them to each other along a y-z plane joint. In other embodiments, baffle 120 may be made by blow molding a parison within a mold.

The tank of grease interceptor 100 may comprise two identical half tanks 105, each having a flange that may be mated at joint 110 by clamping, welding, adhesives, or any method of connection suitable for connecting each half tank 105 at joint 110. The top surface of the upper half tank 105 may have access ports for maintenance, not depicted in FIG. 1. In alternative embodiments, a baffle, such as baffle 120, and associated inflow pipe 125, standpipe 135, and outflow pipe 130 may be placed within other kinds of tanks, for example, in a bottom tank portion shaped like a tub that has a lid on top, or within a two-piece concrete tank.

As depicted in FIG. 1, tank 115 may have orthogonal axes x, y, and z. Baffle 120 may have corresponding x, y, and z axes. During use of grease interceptor 100, the z axis may be vertical, and the x and y axes may lie in the horizontal plane. In some embodiments, as depicted in FIG. 1, grease interceptor 100 may be generally rectanguloid with heavy corrugations and may have a bottom wall, a top wall, opposing side walls and opposing end walls. In other embodiments, tank 115 may comprise walls that are rounded more than those depicted in FIG. 1. In some embodiments, tank 115 may hold about 500 gallons of water. In other embodiments, tank 115 may hold more or fewer gallons of water.

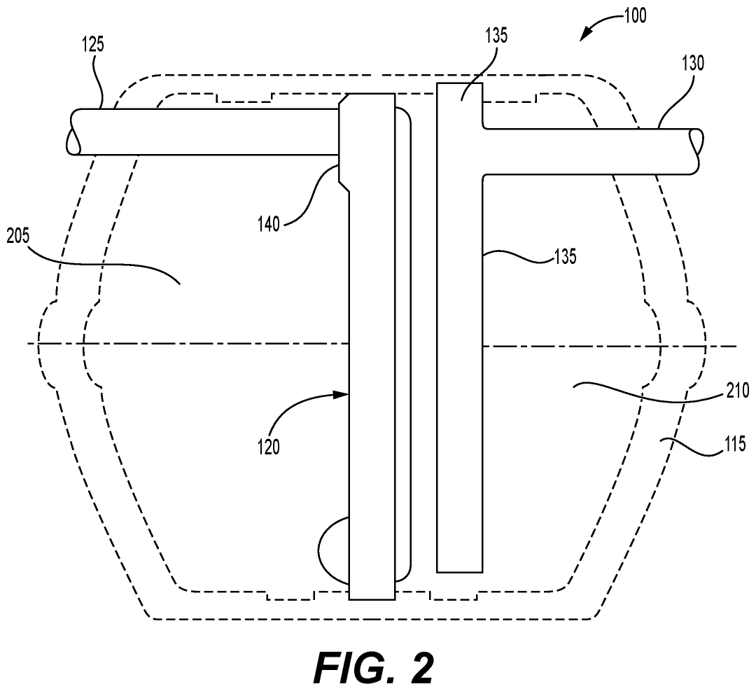

Grease interceptor 100 may further comprise baffle 120. Baffle 120 may be captured within the corrugations of the interior sidewalls of tank 115. Baffle 120 may have a hollow interior configured to accept a flow of wastewater and may divide the interior of tank 115 into a first chamber and a second chamber, as disclosed herein with reference to FIG. 2. For example, inflow pipe 125 may carry wastewater from a source to inflow opening 140 at the top of baffle 120. Inflow opening 140 at the top of baffle 120 may be shaped to receive the discharge end of inflow pipe 125. Baffle 120 may further comprise slot opening 145 at the bottom of baffle 120. Slot opening 145 may comprise a horizontal slot opening that may be shaped to discharge wastewater from within baffle 120 with an upward bias and tendency toward laminar flow. Baffle 120 may further comprise inlet openings 150 and 150A at about one-quarter height of baffle 120. In other embodiments, inlet openings 150 and 150A may be located below mid-elevation of baffle 120. Inlet openings 150 and 150A may be configured to receive an inflow of water from the first chamber of tank 115.

FIG. 2 depicts a section cut of grease interceptor 100 and baffle 120. As depicted in FIG. 2, baffle 120 may divide the interior of tank 115 into first chamber 205 and second chamber 210. In some embodiments, first chamber 205 and second chamber 210 of grease interceptor 100 may have about equal volume. In other embodiments, baffle 120 may be positioned such that first chamber 205 and second chamber 210 have substantially unequal volume. Inflow pipe 125 may carry wastewater from a source to inflow opening 140 at the top of the baffle 120, which may have a hollow interior. In an alternative embodiment, inflow pipe 125 may run downwardly into an opening at the top of baffle 120. Wastewater may flow within baffle 120 through first chamber 205 and second chamber 210 as described in detail below. Ultimately, wastewater may flow into the bottom of standpipe 135 and out the interconnected discharge pipe 130.

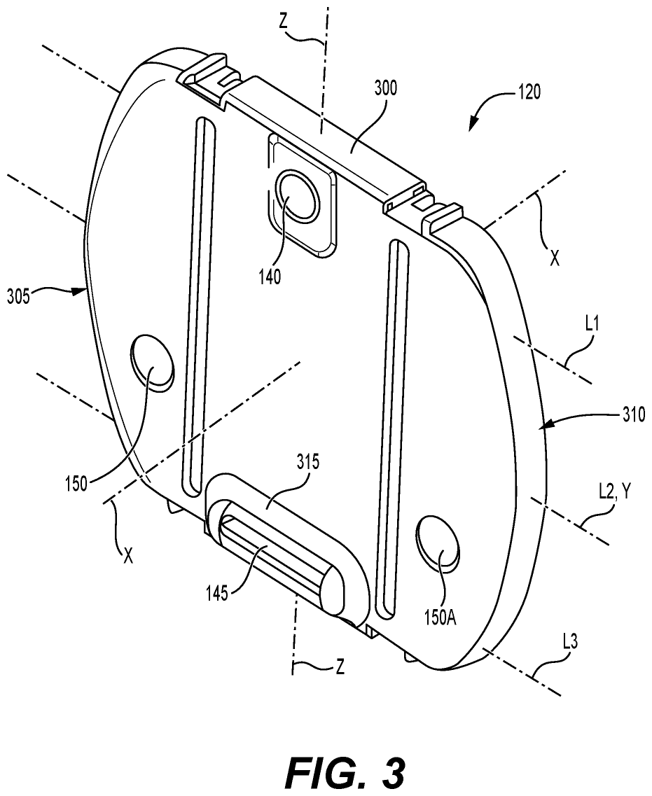

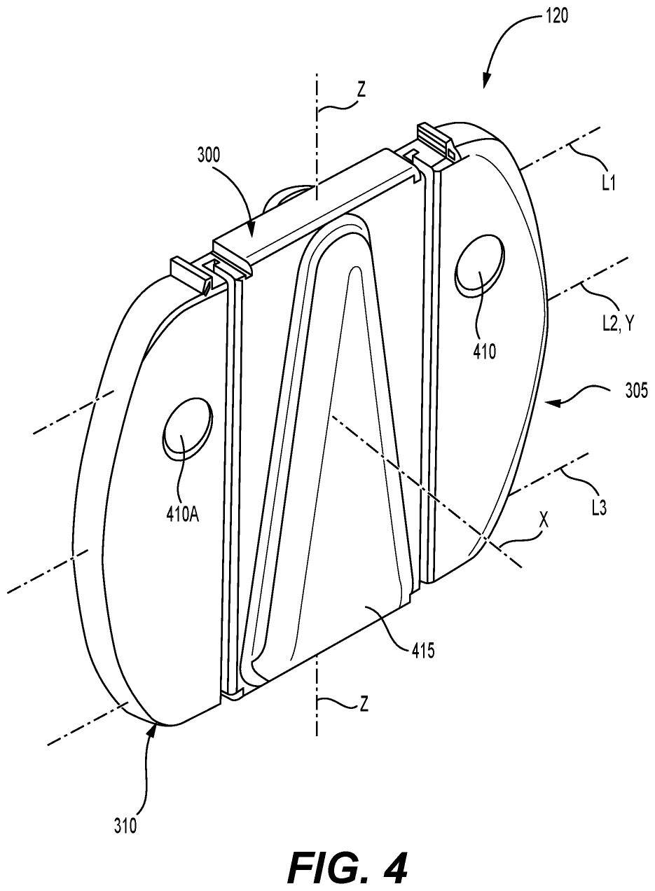

FIG. 3 depicts the upstream side of baffle 120 and FIG. 4 depicts the downstream side of baffle 120. Baffle 120 may comprise three hollow compartments: center compartment 300, first outer compartment 305, and second outer compartment 310. First outer compartment 305 and second outer compartment 310 may be located on opposing sides of center compartment 300. Center compartment 300, first outer compartment 305, and second outer compartment 310 may each comprise a concavity that is not configured to be in substantial flow communication with the adjacent compartments. In some embodiments, the molding method may result in some regions with lateral flow from one compartment to an adjacent compartment. However, such flow may be small compared to the vertical flow within each compartment, to be described below.

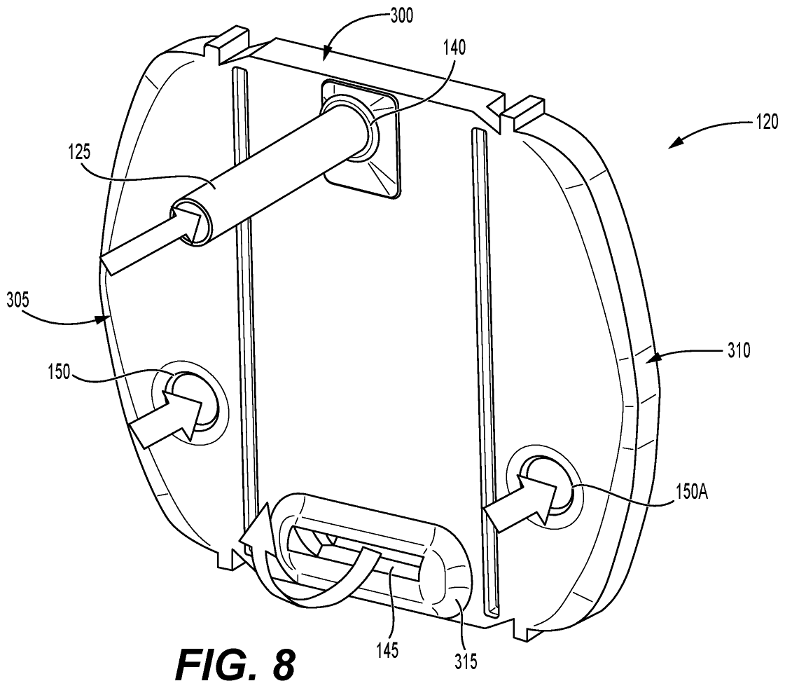

As depicted in FIG. 3, center compartment 300 may comprise inflow opening 140. Inflow opening 140 may be located at the top of center compartment 300 and may comprise an opening for the flow of wastewater into center compartment 300. An inflow pipe, such as inflow pipe 125, may be connected to inflow opening 140 and may carry wastewater from a source into center compartment 300 through inflow opening 140. Center compartment 300 may further comprise slot opening 145. Slot opening 145 may comprise an integral molded boss 315 that may be shaped to discharge water from center compartment 300 with an upward bias and tendency toward laminar flow. First outer compartment 305 may comprise inlet opening 150 and second outer compartment 310 may comprise inlet opening 150A. In some embodiments, inlet openings 150 and 150A may be located at about one-quarter height of baffle 120. In other embodiments, inlet openings 150 and 150A may be located below mid-elevation of baffle 120. Inlet openings 150 and 150A may allow a flow of wastewater to enter first outer compartment 305 and second outer compartment 310, as disclosed herein with reference to FIG. 8.

As depicted in FIG. 4, center compartment 300 may comprise protrusion 415. Protrusion 415 may be generally triangular in shape and may comprise a hollow extrusion from the face of center compartment 300. The interior unit volume of center compartment 300 may increase with downward distance from horizontal-facing inflow opening 140 due to protrusion 415. The increased unit volume of center compartment 300 caused by protrusion 415 may cause a decrease of velocity of wastewater with increasing downward distance from inflow opening 140. In other embodiments, not depicted, center compartment 300 may not include protrusion 415 and may have a constant cross section. In such an embodiment, wastewater flowing downwardly within center compartment 300 would not decrease in velocity within the concavity of center compartment 300.

As depicted in FIG. 4, first outer compartment 305 may comprise outlet opening 410 and second outer compartment 310 may comprise second outlet opening 410A. In some embodiments, outlet openings 410 and 410A may be located at about two-third height of baffle 120. In other embodiments, outlet openings 410 and 410A may be located above the mid-vertical elevation of baffle 120. Outlet openings 410 and 410A may allow discharge of water from first outer compartment 305 and second outer compartment 310 into the second chamber of the tank.

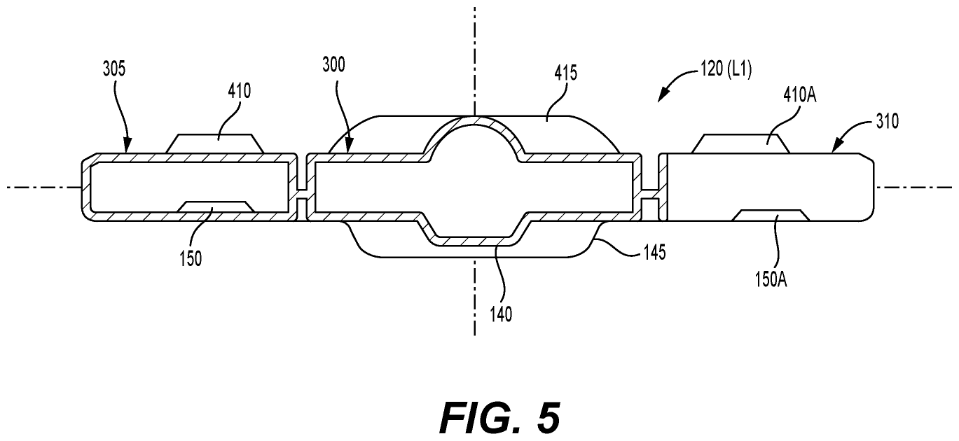

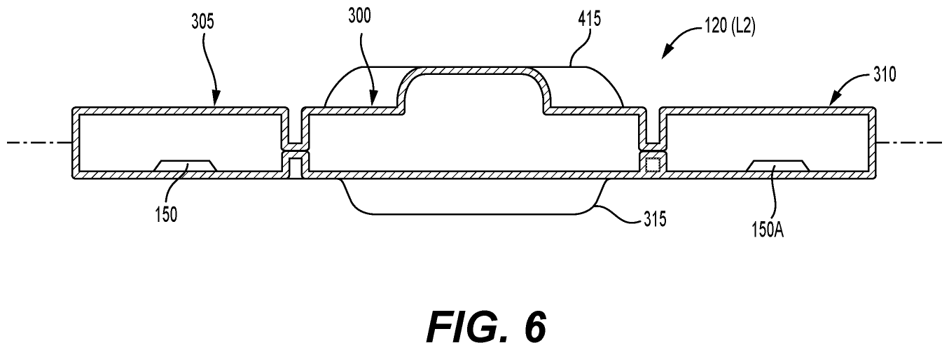

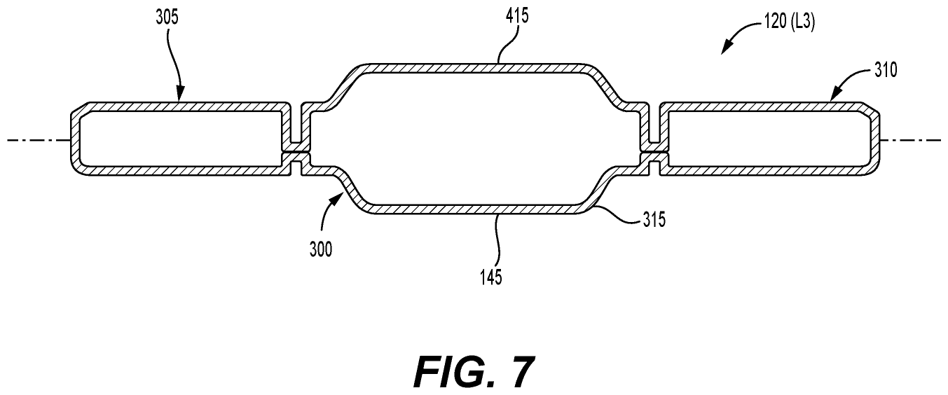

FIGS. 5, 6, and 7 show horizontal plane cross sections of baffle 120 at elevations L1, L2 and L3, as marked on FIGS. 3 and 4. The cross-sectional area (and thus the water-flow area) within center compartment 300 may increase with downward z-axis distance, due to protrusion 415. In some embodiments, baffle 120 may be shaped for placement in a 500-gallon grease interceptor tank and may have a z-axis length of about 50 inches and an x-axis thickness of about 10 inches. The x-y plane flow area of center compartment 300 may be about 94 square inches at level L1, about 116 square inches at level L2, and about 220 square inches at level L3. The inflow pipe 125 may be a 4-inch nominal diameter pipe having a cross sectional flow area of about 12.5 square inches. The increase in cross-sectional area of center compartment 300 with downward z-axis distance may cause the velocity of the wastewater flowing downward through center compartment 300 to decrease. For example, if the velocity of wastewater flowing through inflow pipe 125 is considered 100 percent of the velocity, then the velocity of the wastewater flowing downward through center compartment 300 as measured at L1 may be about 13 percent, the velocity of wastewater flowing downward through center compartment 300 as measured at L2 may be about 11 percent, and the velocity of wastewater flowing downward through center compartment 300 as measured at L3 may be about 5.6 percent. In some embodiments, slot opening 145 of center compartment 300 may be about 28 square inches. In such an embodiment, if the inflow pipe 125 and tank 115 are filled with water, the water velocity exiting center compartment 300 through slot opening 145 may be about 45 percent of the water velocity at the inflow pipe 125.

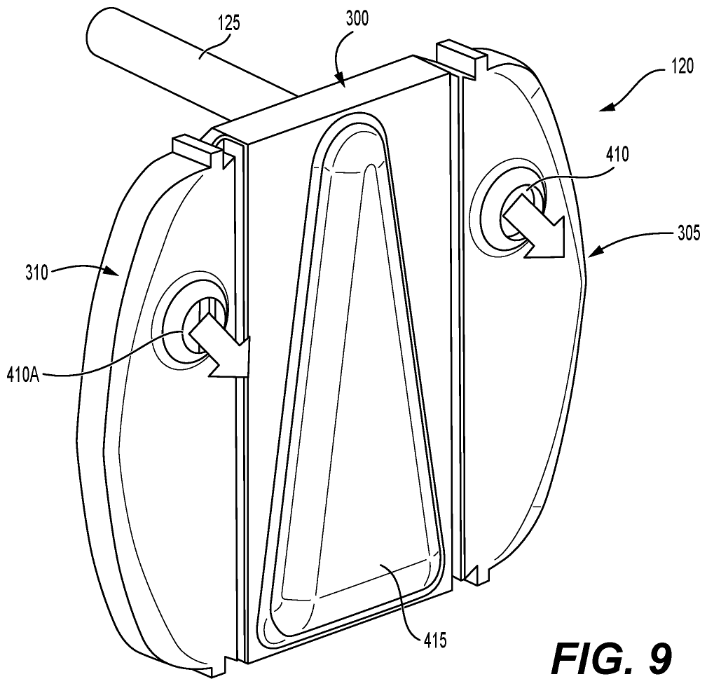

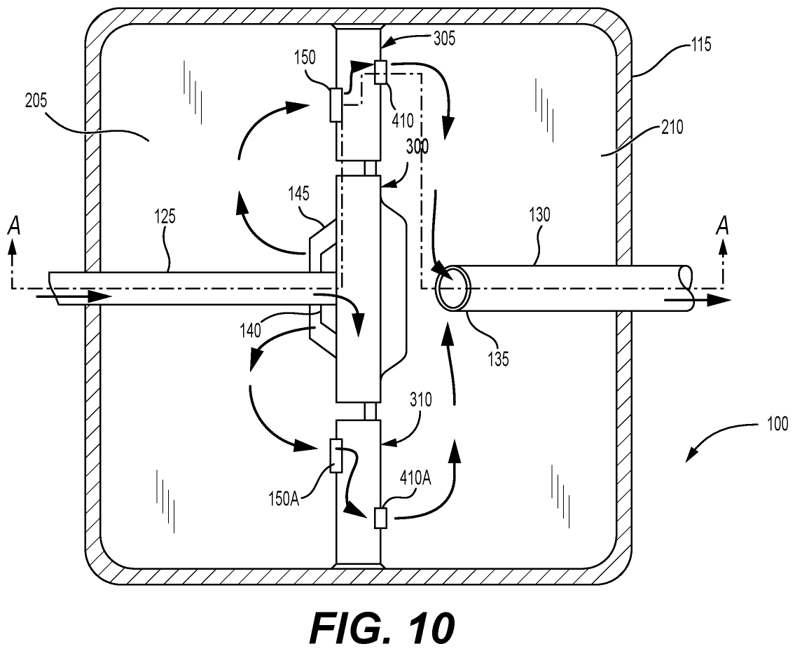

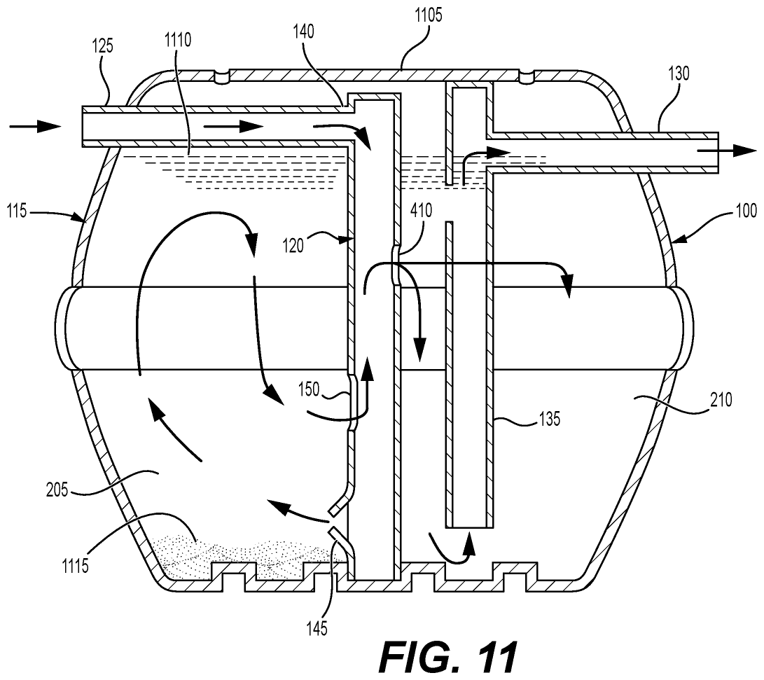

FIGS. 8, 9, 10, and 11 illustrate by means of mostly curving arrows how wastewater may flow through baffle 120 within grease interceptor 100. FIG. 8 depicts the upstream side of baffle 120. FIG. 9 depicts the downstream side of baffle 120. FIG. 10 depicts a top view of grease interceptor 100 with the top wall absent. FIG. 11 depicts a section cut of grease interceptor 100, to show the placement of inflow pipe 125, outflow pipe 130, standpipe 135, and baffle 120 and the surface 1110 of water within grease interceptor 100.

As depicted in FIG. 8, wastewater from a source may flow through inflow pipe 125 and may enter center compartment 300 of baffle 120 through inflow opening 140. The wastewater may flow downward through center compartment 300 and may then flow out of center compartment 300 through slot opening 145 at the bottom of center compartment 300. Slot opening 145 may comprise an integral molded boss 315 that is shaped to discharge water from center compartment 300 with an upward bias and tendency toward laminar flow. The size of slot opening 145 may be larger than the cross-sectional area of inflow pipe 125 and thus the water velocity out of slot opening 145 may be less than the velocity would be if the water was discharged directly from inflow pipe 125 into the first chamber. Water may then flow into first outer compartment 305 through inlet opening 150 and into second outer compartment 310 through inlet opening 150A. As depicted in FIG. 9, water may exit first outer compartment 305 through outlet opening 410 and second outer compartment 310 through outlet opening 410A.

As depicted in FIG. 10 and FIG. 11, wastewater may flow from a source through inflow pipe 125 to inflow opening 140 of center compartment 300 and may exit center compartment 300 through slot opening 145 into first chamber 205. Within first chamber 205, there may be a swirling and then slowing motion of the water, which may enable oil and grease to float upwardly and accumulate in proximity of the water surface 1110. Heavier-than-water solids may sink and accumulate as an aggregation 1115 at the bottom of first chamber 205, as depicted in FIG. 11. Tank 115 may have a removable hatch 1105 or a multiplicity of covered openings, to enable cleaning of grease interceptor 100.

Wastewater may then flow through openings 150 and 150A downward within the hollow interiors of first outer compartment 305 and second outer compartment 310. As more wastewater enters first outer compartment 305 and second outer compartment 310, the wastewater may rise upwardly within the concavities of first outer compartment 305 and second outer compartment 310. Water may then exit first outer compartment 305 through exit opening 410 and second outer compartment 310 through exit opening 410A. Wastewater may then flow downwardly within second chamber 210. The flow of wastewater may slow in velocity due to the size of the second chamber 210. Oil and grease that may remain in the water flowing into the second chamber 210 may accumulate near the surface of the water in second chamber 210 and any heavier-than-water solids may accumulate at the bottom of second chamber 210. The wastewater may then enter the open bottom end of standpipe 135 and may flow upwardly to outflow pipe 130. Outflow pipe 130 may be in flow communication with a municipal sewer line or a septic tank inlet, not shown in FIG. 10 and FIG. 11.

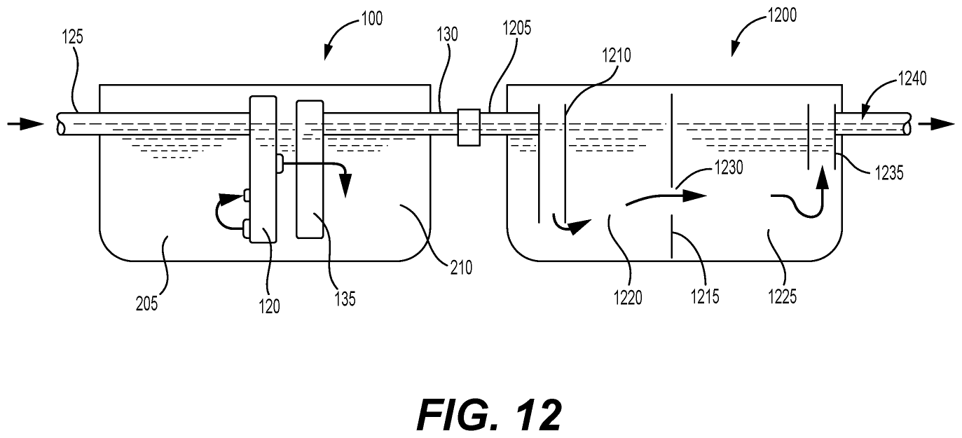

FIG. 12 depicts grease interceptor 100 in combination with a septic tank 1200. As depicted in FIG. 12, grease interceptor 100 and septic tank 1200 may each have a volume of approximately 1000 gallons. In other embodiments, grease interceptor 100 and septic tank 1200 may each have a volume greater than or less than 1000 gallons. As depicted in FIG. 12, grease interceptor 100 may comprise inflow pipe 125 which may be connected to baffle 120. As indicated by arrows, and consistent with the flow path through grease interceptor 100 described above, water may flow through the concavity of baffle 120 and then downwardly into first chamber 205. The wastewater may then flow through the one or more second compartments of baffle 120 into second chamber 210. The wastewater may then flow upward through standpipe 135 to outflow pipe 130. Outflow pipe 130 may be connected to inflow pipe 1205 of septic tank 1200.

Septic tank 1200 may have an upstream chamber 1220 that is separated from downstream chamber 1225 by baffle 1215. Baffle 1215 may have an opening 1230 at an elevation below mid-elevation of baffle 1215. Wastewater may be treated anaerobically in the upstream chamber 1220 and downstream chamber 1225 of septic tank 1200. Wastewater from grease interceptor 100 may enter inflow pipe 1205 and flow down standpipe 1210, which may comprise an internal filter (not shown). Wastewater may then flow within upstream chamber 1220, then through the opening 1230 of baffle 1215 into the downstream chamber 1225 where the water is further treated. Wastewater may then flow downwardly within downstream chamber 1225 to the open lower end of exit standpipe 1235. The wastewater may then flow upwardly through exit standpipe 1235 to outflow pipe 1240 which may be connected to a leach field or other system for subsurface aerobic treatment (not shown).

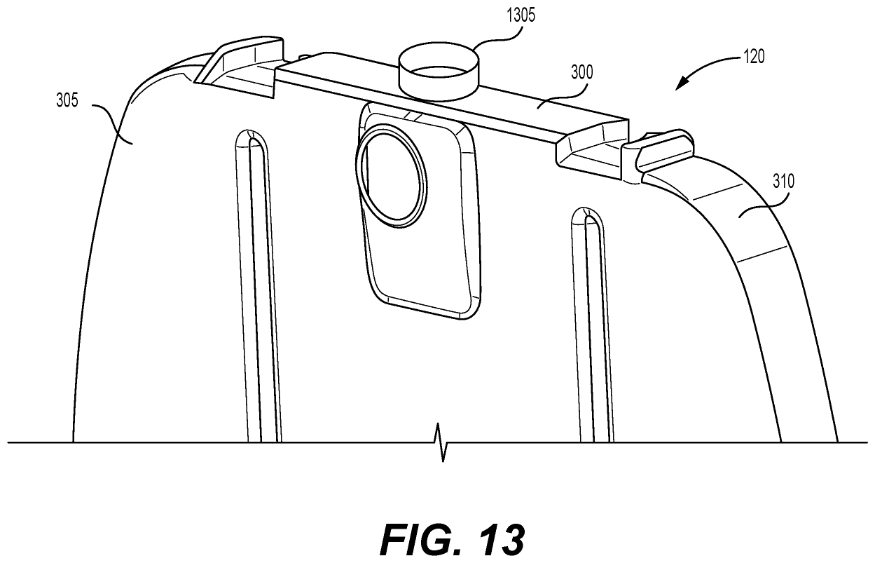

In some embodiments, as depicted in FIG. 13, baffle 120 may comprise an opening 1305 at the top of center compartment 300 for cleaning-access to the interior of baffle 120. In some embodiments, opening 1305 may include a corresponding cap (not shown) to prevent wastewater from flowing out of opening 1305. Similar openings may also be placed at the top of the first outer compartment 305 and the second outer compartment 310.

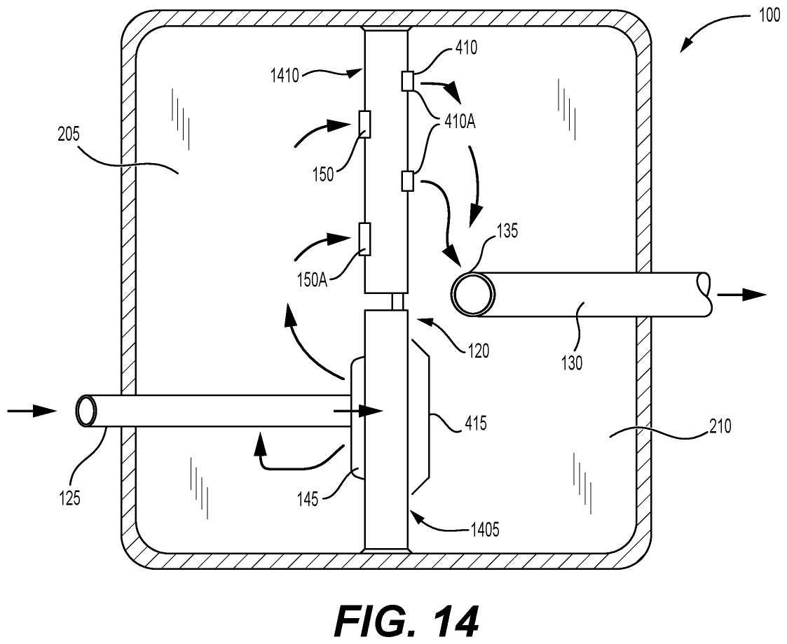

FIG. 14 depicts a top view of an alternative grease interceptor 100 having an alternative embodiment of baffle. In such an embodiment, baffle 120 may comprise a first compartment 1405 and a second compartment 1410. First compartment 1405 may comprise a hollow concavity that may receive a flow of wastewater from a source through inflow pipe 125. First compartment 1405 may further comprise protrusion 415, as disclosed herein. In other embodiments, first compartment 1405 may not include protrusion 415 and may have a constant cross section. Wastewater may flow downwardly through the hollow interior of first compartment 1405 and exit first compartment 1405 into first chamber 205 through slot opening 145.

Second compartment 1410 may comprise a hollow concavity that may receive a flow of wastewater. Second compartment 1410 may not be configured to be in substantial flow communication with first compartment 1405. Second compartment 1410 may comprise inlet openings 150 and 150A on the upstream side of second compartment 1410. In some embodiments, inlet openings 150 and 150A may be located at about one-quarter height of baffle 120. In other embodiments, inlet openings 150 and 150A may be located below mid-elevation of baffle 120. Wastewater may enter the hollow concavity of second compartment 1410 from first chamber 205 through inlet openings 150 and 150A.

Second compartment 1410 may further comprise outlet openings 410 and 410A on the downstream side of second compartment 1410. In some embodiments, outlet openings 410 and 410A may be located at about two-third height of baffle 120. In other embodiments, outlet openings 410 and 410A may be located above the mid-vertical elevation of the height of baffle 120. Outlet openings 410 and 410A may allow discharge of water from second compartment 1410 into second chamber 210 of tank 115. After being discharged through outlet openings 410 and 410A, wastewater may flow up through standpipe 135 and through outflow pipe 130.

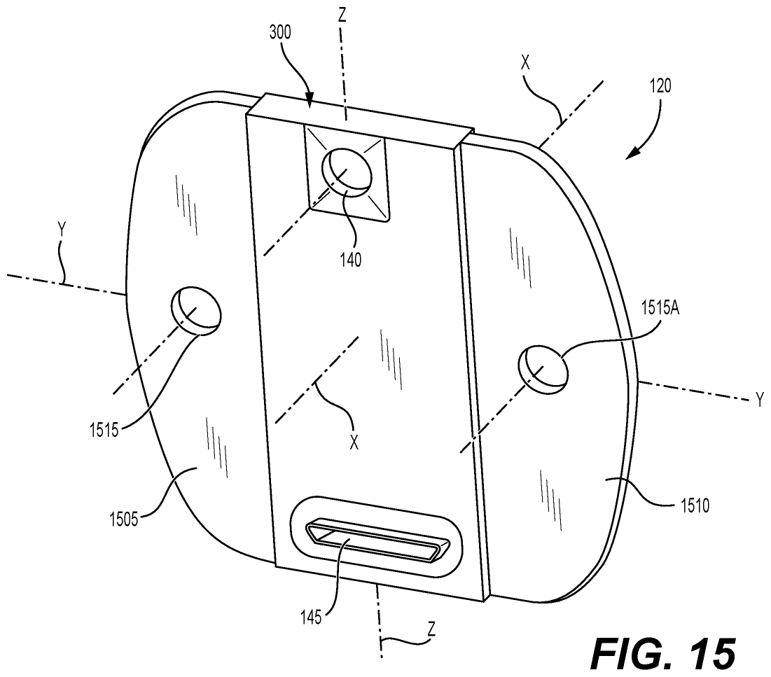

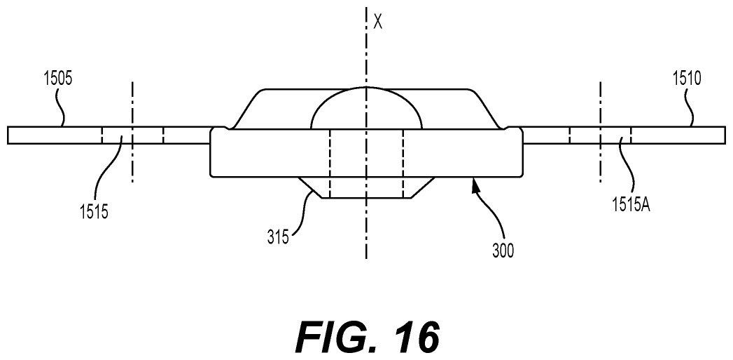

FIG. 15 depicts a perspective view of another alternative embodiment of baffle 120 and FIG. 16 depicts a top view of this alternative embodiment of baffle 120. In such an embodiment, baffle 120 may comprise a hollow center compartment 300, as disclosed herein. Center compartment 300 may comprise inflow opening 140 to receive a flow of wastewater from an inflow pipe and a slot opening 145 to discharge water into the grease interceptor tank, as disclosed herein. In such an embodiment, baffle 120 may further comprise a first side panel 1505 and a second side panel 1510. First side panel 1505 and second side panel 1510 may be solid or hollow with no provision for a flow of wastewater through the interior hollow. First side panel 1505 may comprise opening 1515 and second side panel 1505 may comprise opening 1515A. Openings 1515 and 1515A may be openings to allow wastewater to flow through first side panel 1505 and second side panel 1510 from a first chamber to a second chamber of a grease interceptor tank.

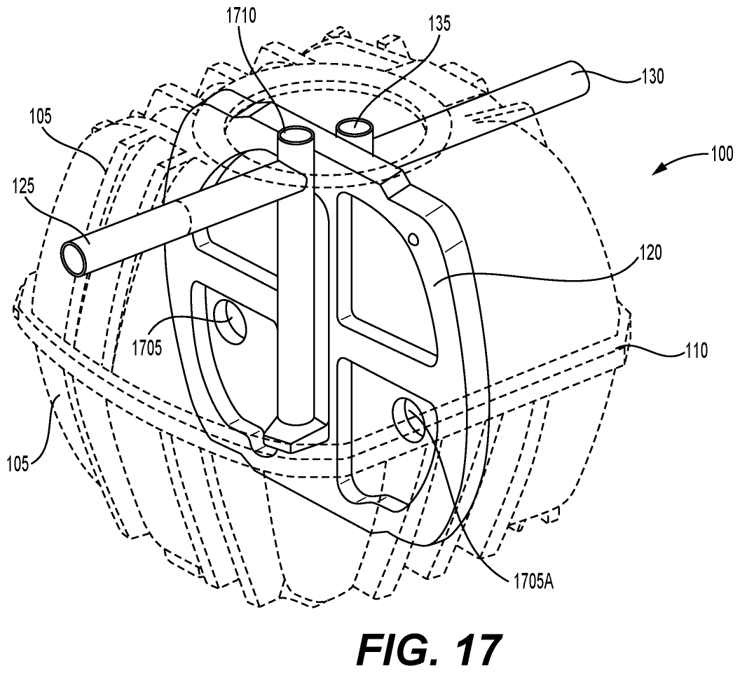

FIG. 17 depicts a perspective view of an alternative embodiment of baffle 120 within grease interceptor 100. The tank of grease interceptor 100 may comprise two identical half tanks 105, each having a flange that is mated at joint 110 by clamping, welding, adhesion, or any other method of connection suitable for connecting half tanks 105. When installed, grease interceptor 100 may comprise a top wall, a bottom wall, opposing side walls, an upstream end wall, and a downstream end wall. The top wall of the upper half tank 110 may have access ports for maintenance (not shown). The configuration of baffle 120, inflow standpipe 1710, and outflow standpipe 145 may allow for access to these components for cleaning and maintenance through only one manhole.

Grease interceptor 100 may additionally comprise baffle 120. Baffle 120 may have a hollow interior with no provisions for flow through the hollow interior. Baffle 120 may be installed within the corrugations of the interior of the sidewalls of the tank, thus dividing the interior of the tank into two chambers. Baffle 120 may further comprise openings 1705 and 1705A, which may allow for the flow of wastewater between the two chambers.

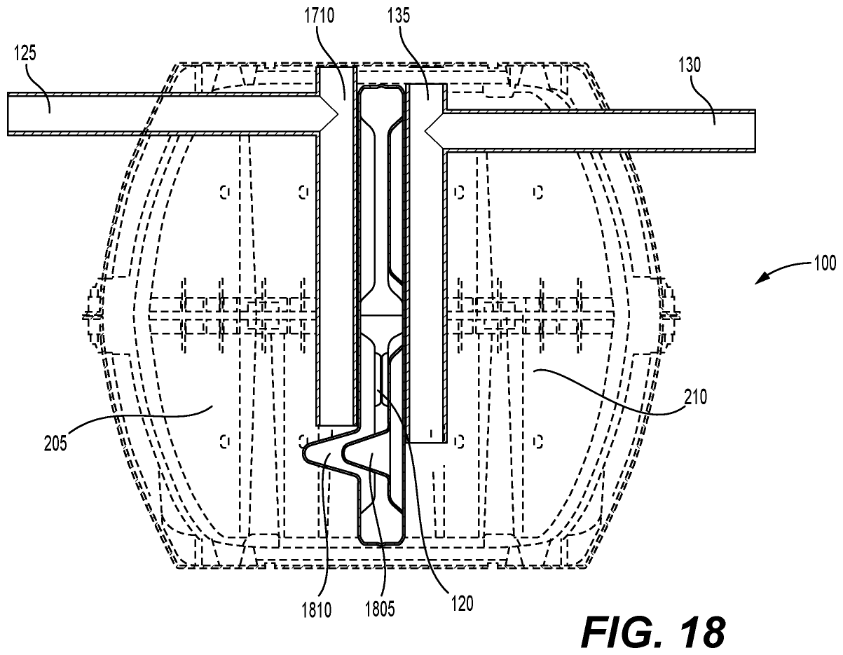

Grease interceptor 100 may further comprise an inflow pipe 125 and an outflow pipe 130, as disclosed herein. Inflow pipe 125 may extend through the upstream end wall of grease interceptor 100 and carry wastewater from a source to inflow standpipe 1710 configured to direct the flow of wastewater to a lower portion of a first chamber 205, as shown in FIG. 18, which depicts a section cut of grease interceptor 100 containing baffle 120. Wastewater may then flow from first chamber 205 to a second chamber 210 through openings 1705 and 1705A in baffle 120. Outflow pipe 130 may extend through the downstream end wall of grease interceptor 100. The flow of wastewater may be directed through outflow standpipe 135 and outflow pipe 130 to exit the second chamber 210 of grease interceptor 100.

As depicted in FIG. 18, baffle 120 may further comprise an internal protrusion 1805 and an external protrusion 1810. Internal protrusion 1805 may comprise a hollow extension that extends from the face of the downstream side of baffle 120 into the hollow interior of baffle 120. External protrusion 1810 may comprise a hollow extension that extends from the face of the upstream side of baffle 120 away from the hollow interior of baffle 120. Internal protrusion 1805 and external protrusion 1810 may facilitate the secure stacking of multiple baffles 120 for storage or transportation. For example, the external protrusion 1810 of baffle 120 may be placed within the interior protrusion of a second baffle to allow a plurality of baffles to be securely stacked. Additionally, external protrusion 1810 may redirect the flow of wastewater towards the center of first chamber 205 as it exits out of inflow standpipe 1710.

As further depicted in FIG. 18, baffle 120 may divide the tank into first chamber 205 and second chamber 210. Inflow pipe 125 may accept a flow of wastewater from a source and the wastewater may be directed through inflow pipe 125 and inflow standpipe 1710 directly into first chamber 205. While wastewater is contained in first chamber 205, contaminants, such as fats, oils, and grease, may float upward and accumulate at the surface of the wastewater. Heavier-than-water solids may sink and accumulate as an aggregation at the bottom of first chamber 205. Wastewater may then flow through openings 1705 and 1705A of baffle 120 from first chamber 205 into second chamber 210.

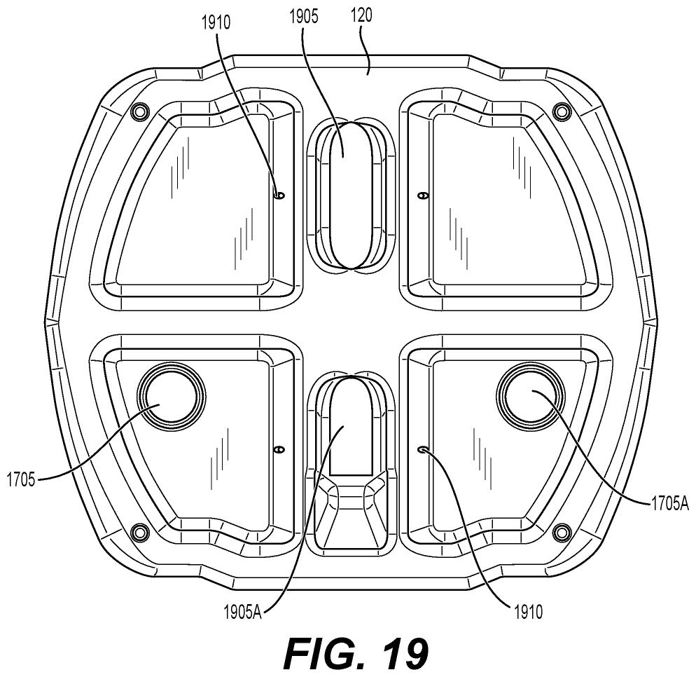

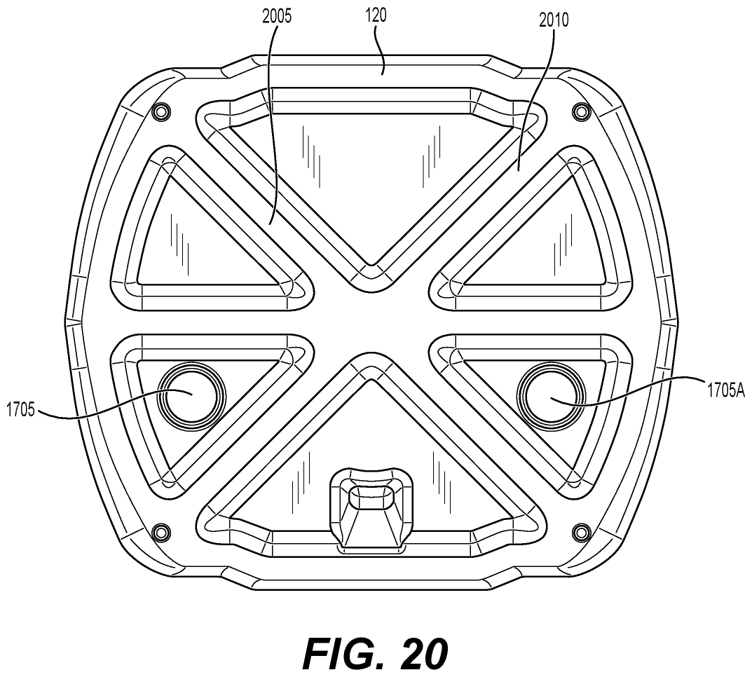

FIG. 19 depicts the upstream side of this alternative embodiment of baffle 120 and FIG. 20 depicts the downstream side of this alternative embodiment of baffle 120. The upstream side of baffle 120 may comprise pipe supports 1905 and 1905A. Pipe supports 1905 and 1905A may comprise extrusions in the face of upstream side of baffle 120 and may accept a pipe such as inflow standpipe 1710. Pipe supports 1905 and 1905A may support a pipe such as inflow standpipe 1710 to prevent movement of inflow standpipe 1710 during operation of grease interceptor 100. The upstream side of baffle 120 may also comprise a plurality of zip tie holes 1910 adjacent to pipe supports 1905 and 1905A. During installation of baffle 120, inflow standpipe 1710 may be placed within pipe supports 1905 and 1905A and zip ties may be used to secure inflow standpipe 1710 to the upstream side of baffle 120 using the plurality of zip tie holes 1910. As depicted in FIGS. 19 and 20, baffle 120 may further comprise openings 150 and 150A. Openings 150 and 150A may allow wastewater to flow from first chamber 205 to second chamber 210 of the grease interceptor 100. Generally, openings 150 and 150A may be below the mid-elevation of a height of baffle 120. The mid-elevation may be nominally half of the height of the baffle 120. The downstream side of baffle 120 may comprise a first diagonal protrusion 2005 and a second diagonal protrusion 2010. First diagonal protrusion 2005 and second diagonal protrusion 2010 may extend vertically from the face of the downstream side of baffle 120 to provide strength and structural support to baffle 120.

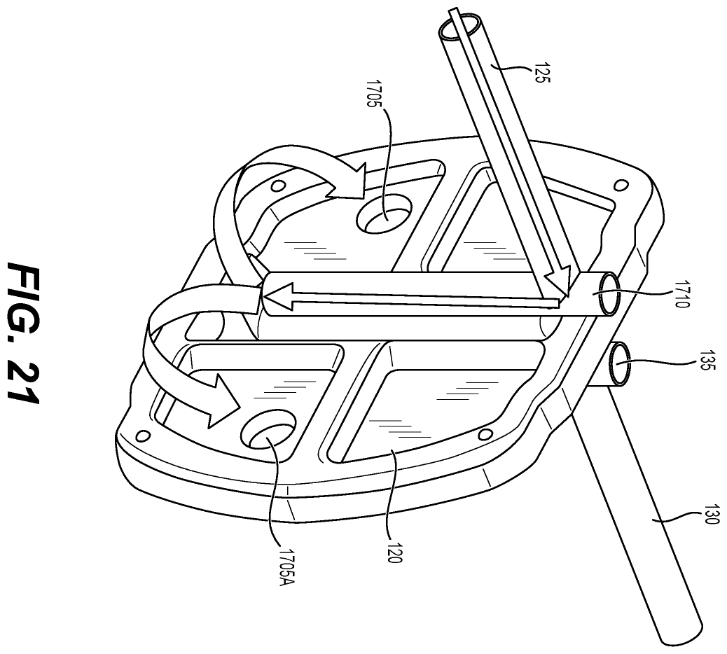

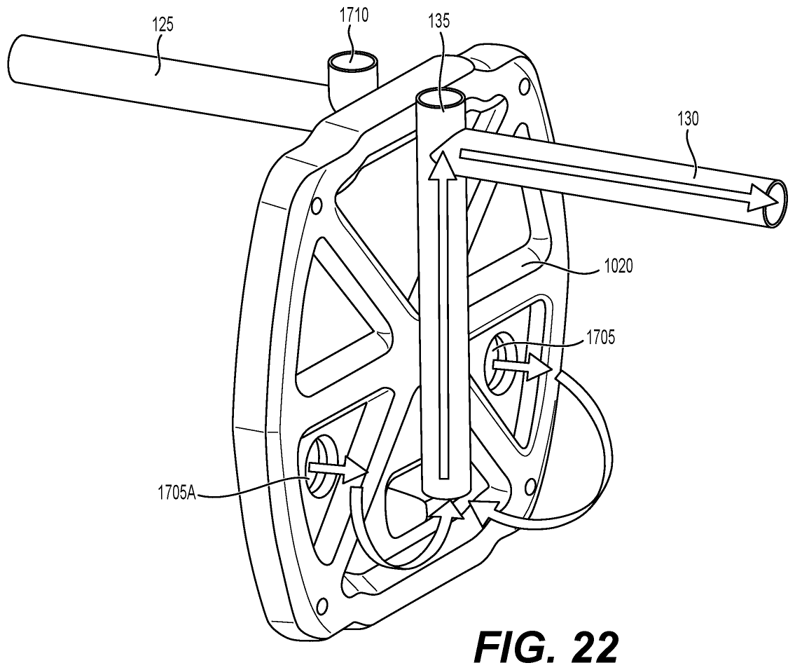

FIGS. 21 and 22 depict the flow of wastewater through grease interceptor 100, with the grease interceptor tank removed for clarity. As depicted in FIG. 21, wastewater may flow from a source through inflow pipe 125 to inflow standpipe 1710. Inflow standpipe 1710 may direct the flow of wastewater to the lower portion of first chamber 205 (depicted in FIG. 18). Within the first chamber 205, there may be a swirling and then slowing motion of the water, enabling oil and grease to float upward and accumulate at the surface of the water in first chamber 205. Heavier-than-water solids may also sink and accumulate as an aggregation at the bottom of first chamber 205. Wastewater may then flow through openings 1705 and 1705A of baffle 120 from first chamber 205 to second chamber 210, as depicted in FIG. 18.

As depicted in FIG. 22, wastewater may flow into second chamber 210 (depicted in FIG. 18) through openings 1705 and 1705A of baffle 120. The oil and grease that remains in the wastewater flowing into second chamber 210 may accumulate near the surface of water in second chamber 210. Any heavier-than-water solids may also accumulate at the bottom of second chamber 210. Wastewater may then flow upwardly through outflow standpipe 135 to outflow pipe 130 which may be in flow communication with a municipal sewer line or a septic tank inlet (not shown in FIG. 22).

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A baffle configured to divide a tank into a first chamber and a second chamber, wherein the baffle comprises:
a hollow center compartment comprising an inflow opening for receiving a flow of wastewater and a slot opening for discharging the flow of wastewater into the first chamber;
a first outer compartment and a second outer compartment located on opposing sides of the center compartment, wherein the first outer compartment and the second outer compartment each comprise an inlet opening for receiving the flow of wastewater from the first chamber and an outlet opening for discharging the flow of wastewater into the second chamber.

2. The baffle of claim 1, wherein the first outer compartment and the second outer compartment each comprise a hollow concavity.

3. The baffle of claim 1, wherein the inflow opening is located at a top end of the center compartment.

4. The baffle of claim 1, wherein the slot opening comprises a horizontal slot opening.

5. The baffle of claim 4, wherein the slot opening comprises an integral molded boss.

6. The baffle of claim 1, wherein the inlet openings of the first outer compartment and the second outer compartment are located below a mid-elevation of the baffle.

7. The baffle of claim 1, wherein the inlet openings of the first outer compartment and the second outer compartment are located at a one-quarter height of the baffle.

8. The baffle of claim 1, wherein the outlet openings of the first outer compartment and the second outer compartment are located above a mid-elevation of the baffle.

9. The baffle of claim 1, wherein the outlet openings of the first outer compartment and the second outer compartment are located at a two-thirds height of the baffle.

10. The baffle of claim 1, wherein the center compartment further comprises a protrusion, the protrusion comprising a hollow extrusion from a face of the center compartment.

11. The baffle of claim 10, wherein the protrusion is triangular in shape.

12. A grease interceptor for treating wastewater by separating and retaining contaminants, comprising:
a tank having a top wall, a bottom wall, opposing side walls, an upstream end wall, and a downstream end wall;
a baffle extending transversely between the opposing side walls and dividing the tank lengthwise into a first chamber and a second chamber, wherein the baffle comprises:
a hollow center compartment having an inflow opening for receiving a flow of wastewater and a slot opening for discharging the flow of wastewater into the first chamber;
a first outer compartment and a second outer compartment located on opposing sides of the center compartment, wherein the first outer compartment and the second outer compartment each comprises an inlet opening for receiving the flow of wastewater from the first chamber and an outlet opening for discharging the flow of wastewater into the second chamber;
an inflow pipe configured to direct the flow of wastewater from a source to the inflow opening; and
an outflow pipe configured to direct the flow of wastewater from the second chamber through an outlet standpipe to an outlet.

13. The grease interceptor of claim 12, wherein the inflow opening is located at a top end of the center compartment.

14. The grease interceptor of claim 12, wherein the slot opening comprises a horizontal slot opening.

15. The grease interceptor of claim 12, wherein a cross sectional area of the slot opening is larger than a cross sectional area of the inflow pipe.

16. The grease interceptor of claim 12, wherein the center compartment further comprises a protrusion, the protrusion comprising a hollow extrusion from a face of the center compartment.

17. The grease interceptor of claim 16, wherein the protrusion is triangular in shape.

18. The grease interceptor of claim 12, wherein a cross sectional area of the slot opening is larger than a cross sectional area of the inflow pipe.

19. The grease interceptor of claim 12, wherein a cross sectional area of the center compartment increases with a decrease in elevation from a top of the baffle.

20. The grease interceptor of claim 12, wherein the slot opening further comprises an integral molded boss.
